(19) United States
(12) Patent Application Publication
(10) Pub. No.: US 2007/0222110 A1
(43) Pub. Date: Sep. 27, 2007

(54) Manufacturing method for an ornament

(76) Inventor: Chi-Min Wang, Rende Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/646,360

(22) Filed: Dec. 28, 2006

(30) Foreign Application Priority Data
Mar. 24, 2006 (TW) 095110173

(51) Int. Cl. B29C 45/00

(52) U.S. Cl. 264/250

(57) ABSTRACT

An ornament is manufactured by a method including following steps: first, injecting materials into a bottom one of material channels of a mold to form a connecting base, which material channels are in open communication with each other; second, injecting materials from an outer periphery of an upper end of the connecting base into the mold to form several branches, which lead away from the connecting base, and which are formed such that joints between the branches and the connecting base being flexible; third, moving tail ends of the branches so that the branch tail ends are close together right above a middle of the connecting base; finally, fastening the branch tail ends together.

### BACKGROUND OF THE INVENTION

1. Field of the Invention

The present invention relates to a manufacturing method for an ornament, more particularly one, which helps reduce the cost of mold development, and allows an ornament to be formed and assembled in less time, with less labor and at a lower cost.

2. Brief Description of the Prior Art

Many people like to decorate their houses and offices with various things such as paintings and ornaments.

However, following problems exist in manufacturing an ornament with many branches:

1. The manufacturer has to develop several molds, and the branches of the ornament have to be formed separately by means of an injection molding process with respective molds. Therefore, the cost of mold development increases, and it takes much time and cost to manufacture the ornament.

2. The branches have to be joined to a main part of the ornament after they are formed therefore it takes relatively much labor to assemble the ornament.

Therefore, it is a main object of the present invention to provide an improvement on a manufacturing method for an ornament to overcome the above-mentioned problems.

### SUMMARY OF THE INVENTION

A manufacturing method for an ornament includes following steps: first, injecting materials into a lowermost one of material channels of a mold so that a connecting base is formed, which material channels are in open communication with each other; second, injecting materials from an outer periphery of an upper end of the connecting base into the mold to form several branches, which lead away from the connecting base, and which are formed such that joints between the branches and the connecting base being flexible; third, moving tail ends of the branches so that the branch tail ends are close together right above a middle of the connecting base; finally, fastening the branch tail ends. Therefore, it takes less manufacturing time, labor and cost to use the method of the present invention than to use the conventional method.

### BRIEF DESCRIPTION OF THE DRAWINGS

The present invention will be better understood by referring to the accompanying drawings, wherein:

FIG. 1 is a perspective view of the present invention,

FIG. 2 is a front sectional view of the present invention,

FIG. 3 is a perspective view of an assembled form of the invention,

FIG. 4 is a front sectional view of an assembled form of the present invention,

FIG. 5 is a perspective view of the present invention (with geometric-shaped branches),

FIG. 6 is a perspective view of an assembled form of the present invention (with lantern-shaped branches),

FIG. 7 is a sectional view of the present invention, taken when injection molding is being carried out,

FIG. 8 is a front sectional view of the present invention, taken when injection molding is being carried out,

FIG. 9 is a perspective view of the present invention (with other shaped branches), and

FIG. 10 is a perspective view of an assembled form of the present invention (with other shaped branches).

### DETAILED DESCRIPTION OF THE PREFERRED EMBODIMENTS

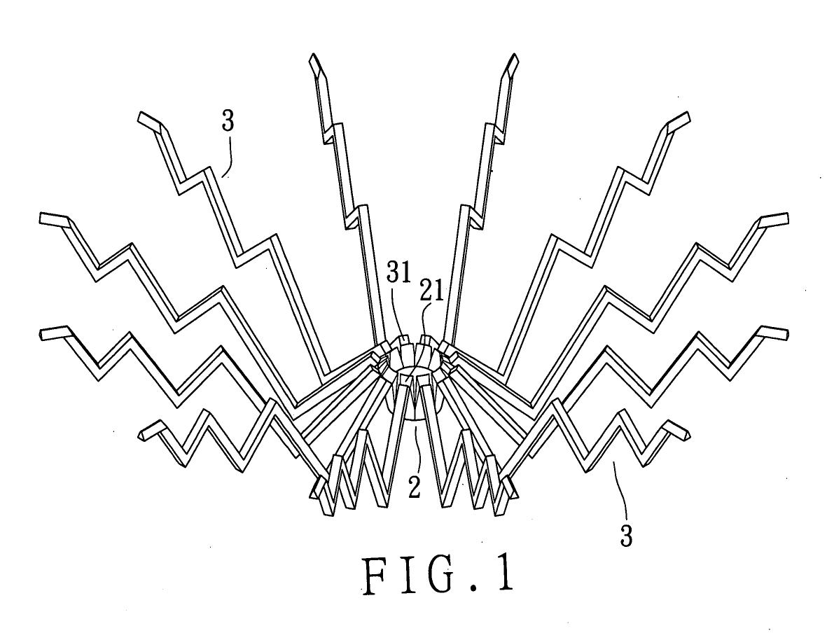

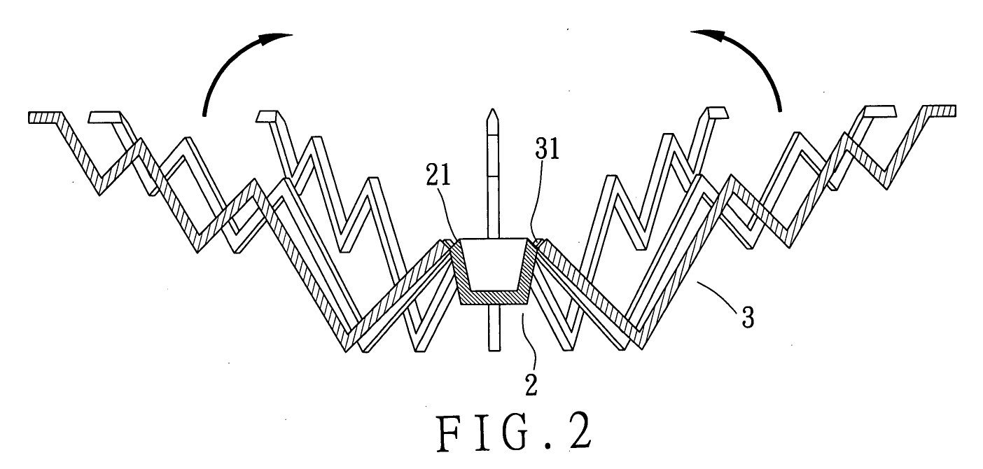

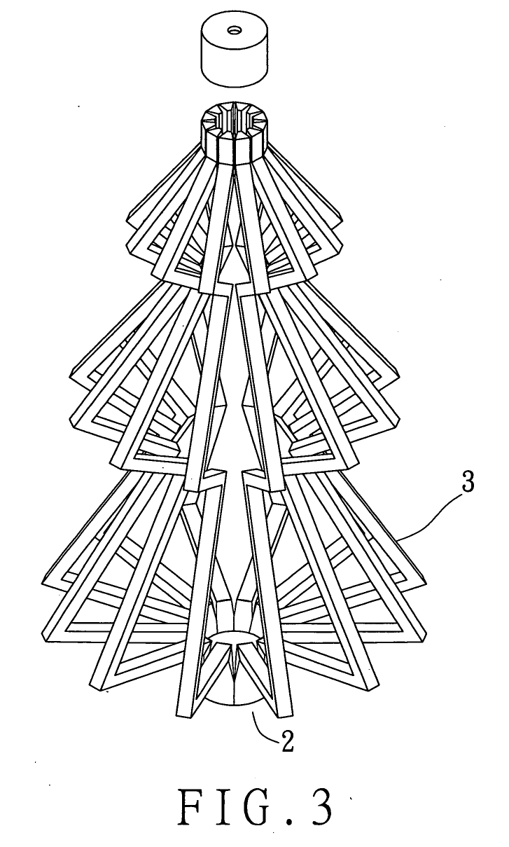

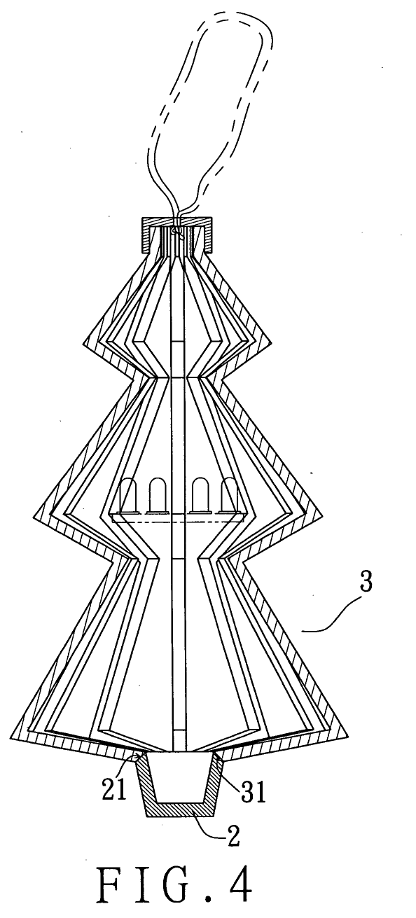

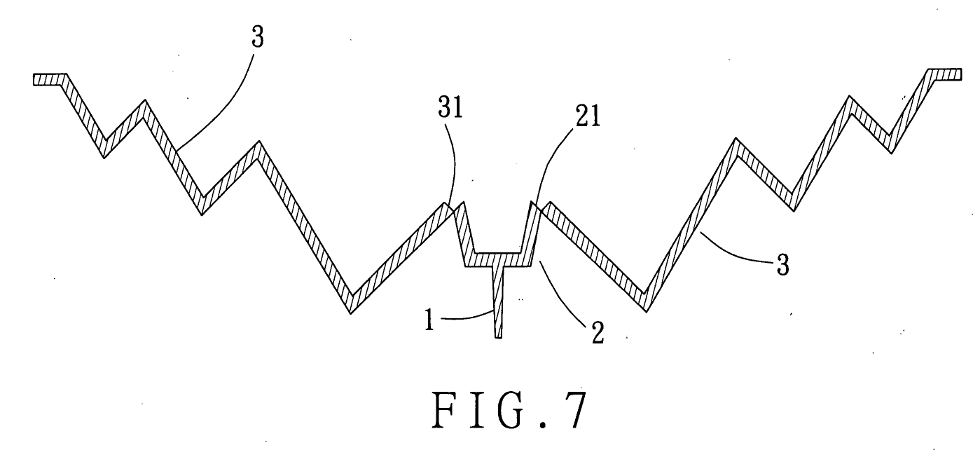

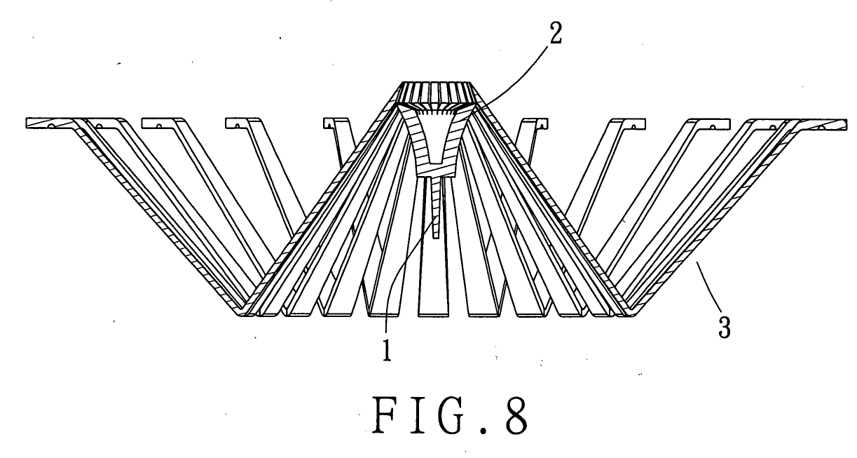

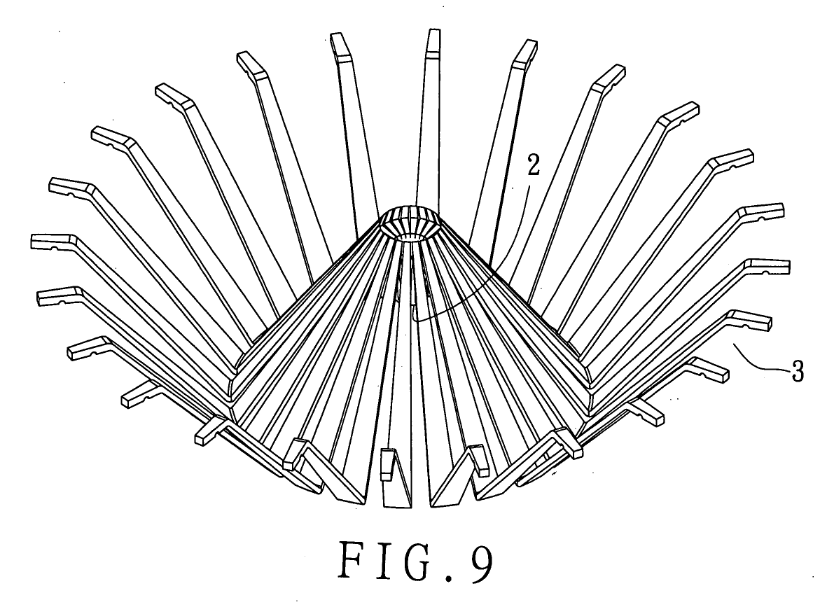

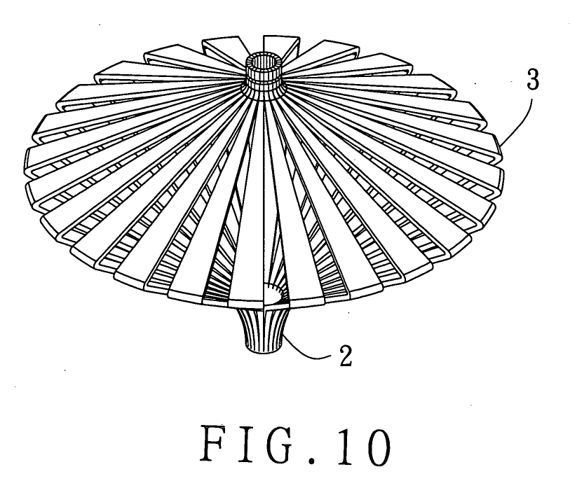

Referring to FIGS. 1 to 10, a preferred embodiment of a manufacturing method for an ornament includes the following steps: first, preparing a mold; second, carrying out injection molding to make an ornament with the mold, which ornament has a connecting base 2, and several branches 3 leading away from the connecting base 2; third, moving tail ends of the branches of the ornament close together and fastening the branch tail ends together.

More detailedly, the mold has several material channels, which communicate with each other, and includes a bottom material channel 1. In the injection molding second step, materials are injected from the bottom material channel 1 to form the connecting base 2 first, and next materials are injected from the outer periphery of the upper end of the connecting base 2 into the mold to form the branches 3; the upper end of the connecting base 2 has an inwardly retreating cone-shaped slope 21, and the branches 3 lead away from a lower edge of the cone-shaped slope 21 of the connecting base 2 in a radial manner; the joints between the branches 3 and the connecting base 2 are flexible. Each of the branches 3 has a joining side 31. The joining sides 31 will be closely in touch with the cone-shaped slope 21 of the connecting base 2 in order for the branches 3 to be propped by the connecting base 2 without possibility of drooping when the tail ends of the branches 3 are moved to be close together right above a middle of the connecting base 2.

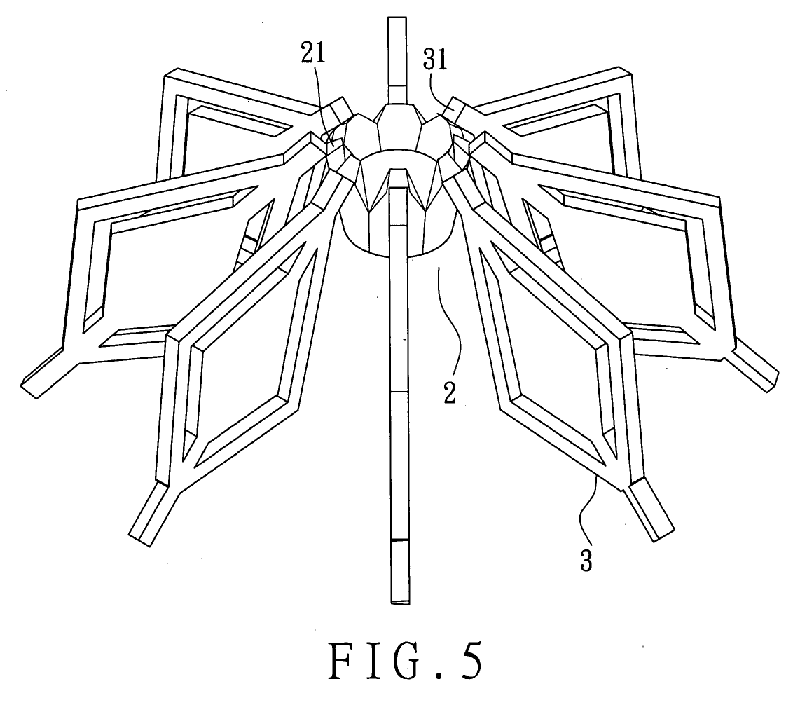

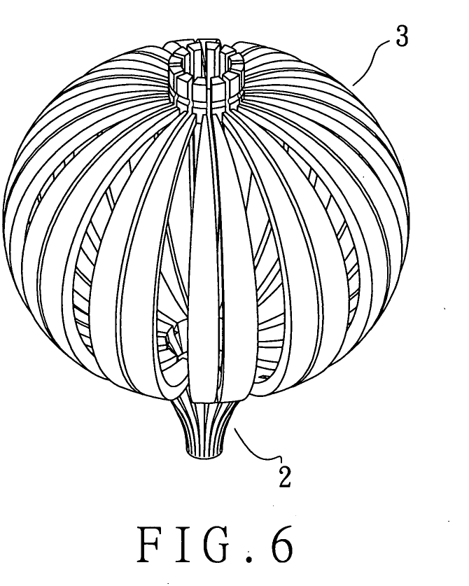

The branches 3 together can be geometric-shaped (as shown in FIG. 5), lantern-shaped (FIG. 6), cartoon figures, animals, palace lanterns or other shaped.

In the third step, the tail ends of the branches 3 are first moved so as to be close together right above a middle of the connecting base 2, and next the tail ends of the branches 3 are fastened together.

Referring to FIGS. 1 to 10 again, in manufacturing, first materials are injected into the mold from the bottom material channel 1 to form a connecting base 2, which has an inwardly retreating cone-shaped slope 21 at an upper end thereof. And, materials are injected from the outer periphery of the upper end of the connecting base 2 into the mold to form several branches 3, which lead away from a lower edge of the cone-shaped slope 21 of the connecting base 2 in a radial manner. Next, tail ends of the branches 3 are moved to be close together right above a middle of the connecting base 2, with joining sides 31 of the branches 3 being closely in touch with the cone-shaped slope 21 of the connecting base 2 in order for the branches 3 to be propped and prevented from hanging down by the connecting base 2. Finally, the tail ends of the branches 3 are fastened together.

From the above description, it can be seen that the present invention has the following advantages:

1. It takes less manufacturing time and cost to use the method of the present invention than to use the conventional method because the whole ornament is formed by means of injection molding using single mold in the present method, but several molds are used in the conventional method.

2. It takes much less labor and time to use the method of the present invention to manufacture the ornament because after injection molding, the tail ends of the branches of the ornament only have to be moved close together and fastened in assembling.

What is claimed is:

1. A manufacturing method for an ornament, comprising following steps:
injecting materials from a bottom one of a plurality of material channels of a mold so as to form a connecting base; said material channels of said mold communicating with each other;
injecting materials from an outer periphery of an upper end of the connecting base into the mold to form a plurality of branches, which lead away from the connecting base; joints between the branches and the connecting base being flexible; and
moving tail ends of the branches so that the branch tail ends are close together right above a middle of the connecting base, plus fastening the tail ends of the branches together.

2. The manufacturing method for an ornament as recited in claim 1, wherein the branches can be in one of various shapes.

3. The manufacturing method for an ornament as recited in claim 1, wherein the connecting base is in such a shape as to match the branches.
